(19) United States
(12) Patent Application Publication
(10) Pub. No.: US 2025/0290555 A1
(43) Pub. Date: Sep. 18, 2025

(54) ACTIVE VIBRATION DAMPING DEVICE AND METHOD OF MANUFACTURING THE SAME

(71) Applicant: HONDA MOTOR CO., LTD., Tokyo (JP)

(72) Inventors: Yuho ITO, Wako-shi (JP); Toshio INOUE, Wako-shi (JP)

(21) Appl. No.: 19/054,147

(22) Filed: Feb. 14, 2025

(30) Foreign Application Priority Data
Mar. 15, 2024 (JP) 2024-041178

(51) Int. Cl. F16F 9/53; B60G 13/00; B60G 13/06

(52) U.S. Cl. CPC F16F 9/535; B60G 13/005; B60G 13/06; B60G 2204/41; B60G 2206/41; F16F 2226/04; F16F 2230/0005

(57) ABSTRACT

Provided is an active vibration damping device including: an outer cylinder; an inner cylinder disposed on an inner peripheral side of the outer cylinder; a magnetic field generator that generates a magnetic field; a magnetic body that forms a magnetic path by the magnetic field; a first liquid chamber filled with a magneto-viscoelastic fluid; a second liquid chamber adjacent to the first liquid chamber and filled with liquid, wherein the magnetic field generator, the magnetic body, the first liquid chamber, and the second liquid chamber are provided between the inner cylinder and the outer cylinder in the radial direction, the first liquid chamber and the second liquid chamber are partitioned by a flexible member, the flexible member extends in an axial direction of the inner cylinder, and a part of the first liquid chamber forms a flow path for the magnetic viscoelastic fluid positioned on the magnetic path.

### CROSS-REFERENCE TO RELATED APPLICATION

This application is based upon and claims priority from the Japanese Patent Application No. 2024-041178, filed on Mar. 15, 2024, the entire contents of which are incorporated herein by reference.

### BACKGROUND OF THE INVENTION

### Field of the Invention

The present invention relates to an active vibration damping device and a method of manufacturing the same.

### Description of the Related Art

In recent years, efforts have been made to provide access to sustainable transportation systems that also take into account vulnerable traffic participants, such as the elderly, disabled or children. In order to realize this, research and development have been carried out for further improving safety and convenience of traffic through development related to the habitability of vehicles. Conventionally, an active vibration damping device used for a subframe mount, a suspension bush, or the like has been proposed for the purpose of improving the comfort of a vehicle by suppressing noise and vibration in a vehicle cabin (for example, see Japanese Patent Application Laid-Open No. 2021-71117.) Specifically, this active vibration damping device has two liquid chambers filled with a magneto-viscoelastic fluid and connected to each other by a flow path and an excitation coil that forms a magnetic path in a direction intersecting the flow path. In this active vibration damping device, the magneto-rheological fluid attempts to flow through the flow passage from one of the liquid chambers toward the other liquid chamber in accordance with the magnitude of the amplitude of the input vibration. In this case, the active vibration damping device controls the flow of the magneto-viscoelastic fluid by varying the magnetic flux density generated by the excitation coil. Thus, the active vibration damping device exhibits damping characteristics that are flexible in accordance with the magnitude of the input vibration amplitude.

### SUMMARY OF THE INVENTION

In a conventional active vibration damping device (see Japanese Patent Application Laid-Open No. 2021-71117), the volume of the liquid chamber can be increased for the purpose of improving the response performance with respect to the amplitude of the input vibration, but the amount of the relatively heavy and expensive magneto-viscoelastic fluid containing magnetic powder filled in the liquid chamber must also be increased. This causes a new problem that manufacturing cost of the active vibration damping device is increased and the weight of the vehicle on which the active vibration damping device is mounted is also increased. Further, in the active vibration damping device, when the amount of the magnetic viscoelastic fluid increases, the absolute precipitated amount of the magnetic powder contained in the magnetic viscoelastic fluid also increases, which affects the performance of the active vibration damping device.

An object of the present invention is to provide an active vibration damping device capable of improving response performance to external force such as input vibration and load without increasing the volume of the liquid chamber filled with the magnetic viscoelastic fluid and also capable of suppressing performance deterioration due to precipitation of magnetic powder contained in the magnetic viscoelastic fluid in the liquid chamber. This will in turn contribute to the development of sustainable transport systems.

A first aspect of the present invention is an active vibration isolator comprising an outer cylinder, an inner cylinder disposed on an inner peripheral side of the outer cylinder, a magnetic field generator for generating a magnetic field, a magnetic body for forming a magnetic path by the magnetic field, a first liquid chamber filled with a magneto-viscoelastic fluid, and a second liquid chamber adjacent to the first liquid chamber and filled with a liquid.

A second aspect of the present invention is a method of manufacturing the active vibration damping device, including: manufacturing a second liquid chamber forming portion which forms the second liquid chamber by integrally molding the elastic body on an outer surface of the inner cylinder; manufacturing a first liquid chamber forming portion by combining the magnetic field generator, the magnetic body, and the flexible member in a liquid made of the magnetic viscoelastic fluid to make the first liquid chamber filled with the magnetic viscoelastic fluid; manufacturing an assembled body by assembling the first liquid chamber forming portion and the second liquid chamber forming portion in such a manner that the first liquid chamber and the second liquid chamber are partitioned by the flexible member extending in the axial direction of the inner cylinder and are supported by the magnetic body and the magnetic body and the inner cylinder are connected by the elastic body; and fixing the assembled body in the outer cylinder by inserting the assembled body into the outer cylinder in the liquid so that the second liquid chamber is filled with the liquid.

According to the active vibration damping device and the method of manufacturing the same according to the present invention, it is possible to improve the response performance to external forces such as vibrations and loads input without increasing the volume of the liquid chamber filled with the magnetic viscoelastic fluid, and it is also possible to suppress a decrease in performance due to precipitation of the magnetic powder of the magnetic viscoelastic fluid in the liquid chamber.

### BRIEF DESCRIPTION OF THE DRAWINGS

FIG. 1A is a partial enlarged perspective view of a rear suspension including an active vibration damping device according to an embodiment of the present invention.

FIG. 1B is an overall perspective view of an active vibration damping device according to the embodiment of the present invention.

FIG. 2A is a cross sectional view taken along line IIA-IIA of FIG. 1B.

FIG. 2B is a cross-sectional view taken along IIB-IIB of FIG. 1B.

FIG. 3 is an exploded perspective view of the active vibration damping device shown in FIG. 1B.

FIG. 4 is an overall perspective view of an assembly of a first liquid chamber forming portion and a second liquid chamber forming portion constituting the active vibration damping device.

FIG. 5 is a cross sectional view taken along line V-V in FIG. 1B.

FIG. 6 is an overall perspective view of a cage embedded in a second liquid chamber forming portion.

FIG. 7 is an exploded perspective view of a first liquid chamber forming portion constituting the active vibration damping device.

FIG. 8 is a partial enlarged perspective view of the active vibration damping device including a section taken along line VIII-VIII in FIG. 2B.

FIG. 9 is a schematic view showing the movement of the magnetic powder when a magnetic field is applied to the orifice of the first liquid chamber.

FIG. 10A is an overall perspective view of an active vibration damping device according to another embodiment of the present invention.

FIG. 10B is a cross sectional view taken along line XB-XB of FIG. 10A.

### DETAILED DESCRIPTION OF THE EMBODIMENTS

Next, embodiments for carrying out the active vibration damping device of the present invention will be described in detail with reference to the drawings as appropriate. Hereinafter, an active vibration damping device used for a suspension of a vehicle will be described as an example, but the present invention is not limited thereto, and can be applied to a vehicle soundproof vibration damping device such as a mount bush disposed between members connected to a vehicle body frame (including a sub-frame). First, the overall structure of a rear suspension to which the active vibration damping device of the present embodiment is applied will be described, and then the active vibration damping device will be described in further detail.

### <<Rear Suspension>>

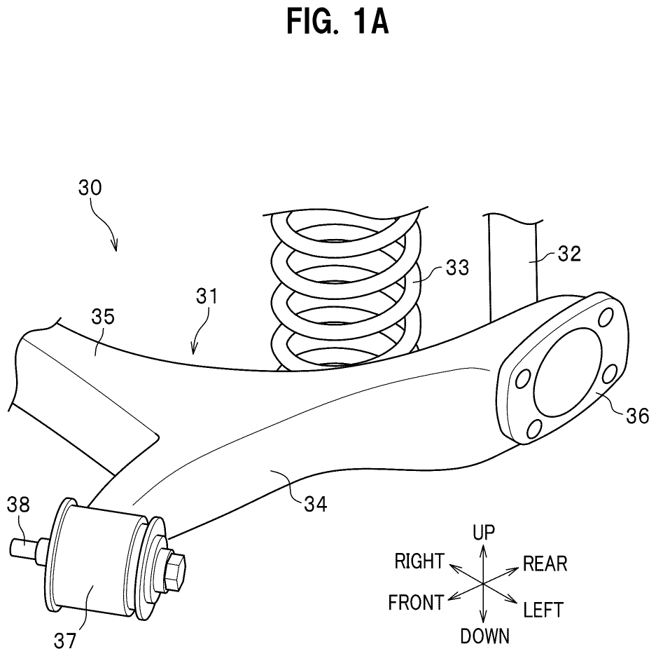

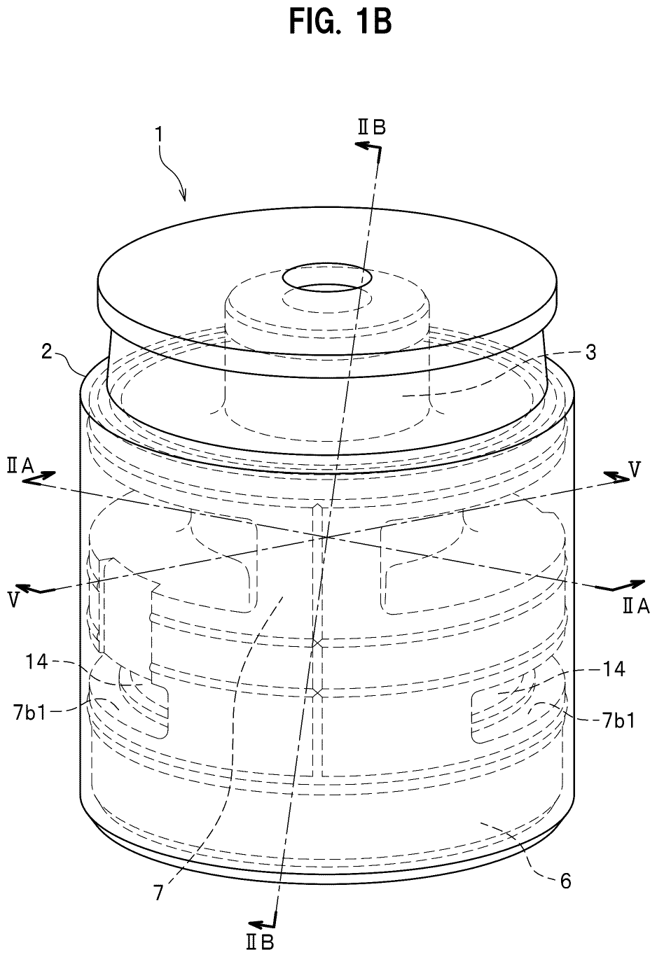

FIG. 1A is a partially enlarged perspective view of a rear suspension 30 including the active vibration damping device 1 of the present embodiment. In the following description, the directions of up, down, left, right, front, and rear are based on the directions of arrows in FIG. 1A.

As shown in FIG. 1A, the rear suspension 30 is a semi-trailing suspension mainly including a suspension arm 31, a rear damper 32 having one end attached to the suspension arm 31 and the other end supported on a vehicle body frame (not shown), and a coil spring 33 supported by the suspension arm 31.

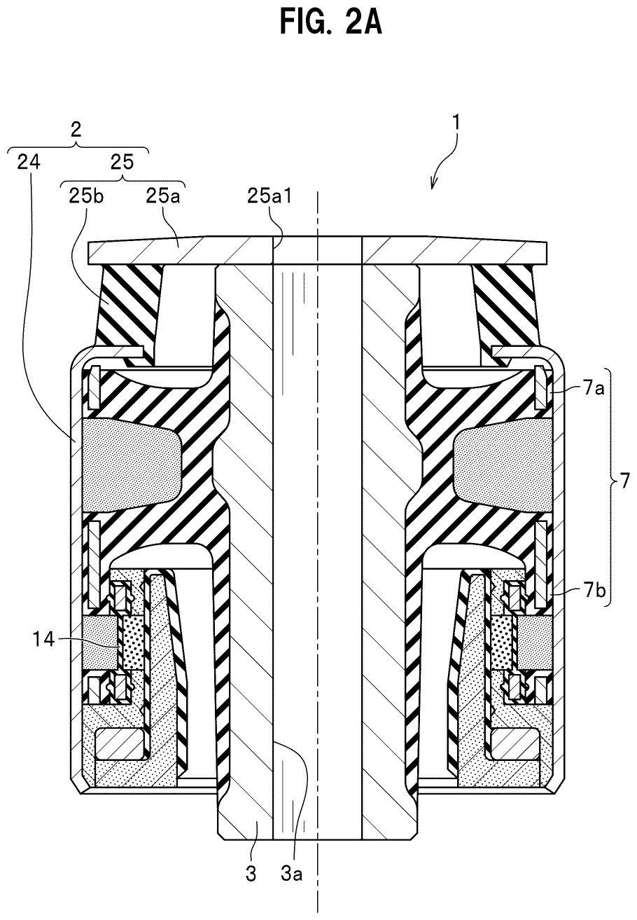

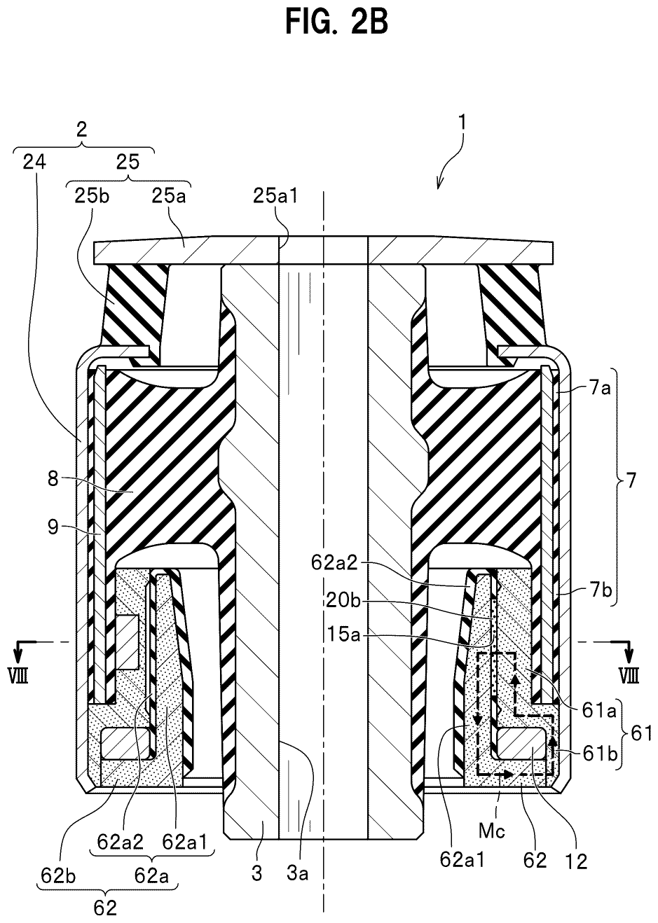

The suspension arm 31 includes a trailing arm 34, a cross beam 35, and a knuckle 36 that supports a rear wheel (not shown) provided on the trailing arm 34. A bush 37 for swingably mounting the trailing arm 34 to a vehicle body frame (not shown) is mounted to the front end of the trailing arm 34. The bush 37 is an active vibration damping device of the present embodiment, and is hereinafter referred to as an active vibration damping device 1. The front end of the trailing arm 34 is attached to an outer cylinder 2 (see FIG. 2A), which will be described later, of the active vibration damping device 1. The active vibration damping device 1 is mounted on a predetermined bracket (not shown) provided on a vehicle body frame (not shown) via a support shaft 38. The support shaft 38 is inserted through an inner cylinder 3 (see FIG. 2A), which will be described later, of the active vibration damping device 1.

### <<Active Vibration Damping Device>>

FIG. 1B is an overall perspective view of the active vibration damping device 1 of the present embodiment. FIG. 2A is a cross-sectional view taken along line IIA-IIA of FIG. 1B. FIG. 2B is a cross-sectional view taken along IIB-IIB of FIG. 1B. In FIG. 1B, the outer cylinder 2 is drawn by a solid line, and the inner cylinder 3, the first liquid chamber forming portion 6, and the second liquid chamber forming portion 7 which are disposed inside the outer cylinder 2 are drawn by hidden lines (dotted lines) among the components of the active vibration damping device 1. In FIG. 1B, the reference numeral 14 denotes a flexible member of the first liquid chamber forming portion 6 which faces the outside of the second liquid chamber forming portion 7 through a slit 7b1 (described later) of the second liquid chamber forming portion 7.

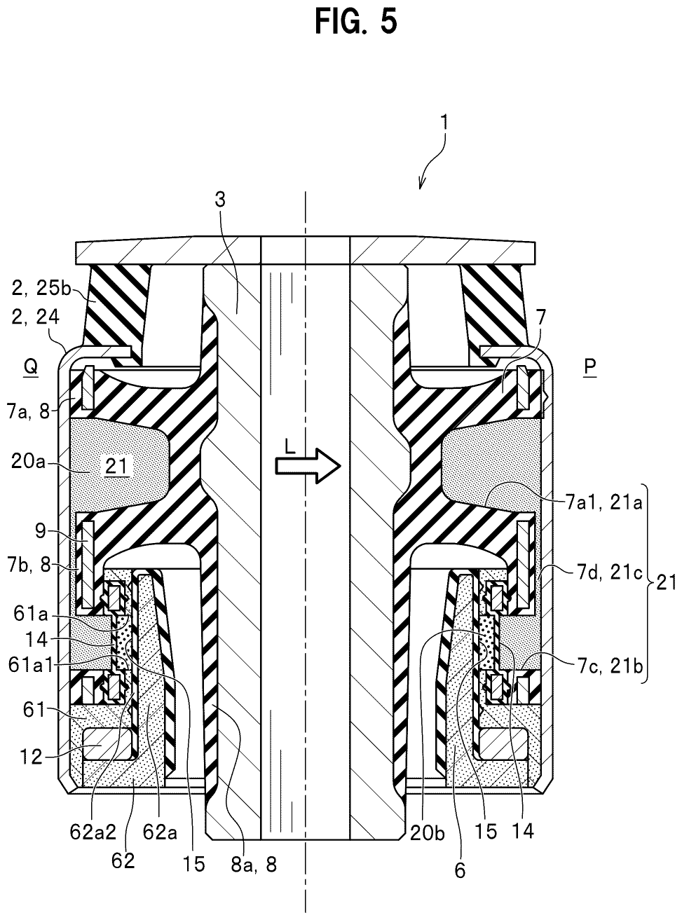

As shown in FIG. 1B, the active vibration damping device 1 has a cylindrical outer shape. As shown in FIG. 2A and FIG. 2B, the active vibration damping device 1 includes an outer cylinder 2 and an inner cylinder 3 disposed substantially coaxially on the inner peripheral side of the outer cylinder 2. As will be described in detail later, a first liquid chamber forming portion 6 (see FIG. 5) that forms a first liquid chamber 15 (see FIG. 5) and a second liquid chamber forming portion 7 (see FIG. 5) that forms a second liquid chamber 21 (see FIG. 5) are disposed between the outer cylinder 2 and the inner cylinder 3.

As shown in FIG. 2B, an orifice 15a is formed as a part of the first liquid chamber 15 in the first liquid chamber forming portion 6. The orifice 15a forms a throttle portion having a cross-sectional area smaller than that of the first liquid chamber 15 as a general portion shown in FIG. 2A. As will be described in detail later, the orifice 15a is positioned on a magnetic path Mc which is to be formed by a magnetic field generated by an electromagnetic coil 12 (magnetic field generator) shown in FIG. 2B.

### <Outer Cylinder>

As shown in FIG. 2A and FIG. 2B, the outer cylinder 2 is formed of a bottomed cylindrical body. The outer cylinder 2 includes a cylindrical outer cylinder main body 24 and a lid body 25 that closes one open end portion of the outer cylinder main body 24. The cover 25 has a disc portion 25a arranged to abut against one end surface of the inner cylinder 3, and a synthetic rubber-made cylindrical elastic portion 25b for vulcanization-bonding the end portion of the outer cylinder main body 24 and the cover 25. The disc portion 25a has an opening 3a at the center thereof, which has the same radius as the hole portion 25al of the inner cylinder 3. In the present embodiment, the outer cylinder body 24 and the disc portion 25a of the cover 25 are made of a nonmagnetic material. Examples of the non-magnetic material include, but are not limited to, an aluminum alloy, non-ferrite SUS, and copper.

### <Inner Cylinder>

As shown in FIG. 2A and FIG. 2B, the inner cylinder 3 is formed to be longer than the outer cylinder main body 24 in the axial direction. The axial end of the inner cylinder 3 slightly protrudes axially outward from the end of the outer cylinder body 24. The inner cylinder 3 in the present embodiment is formed of a non-magnetic material. A support shaft 38 (see FIG. 1A) is inserted through the opening 3a of the inner cylinder 3 and the hole portion 25al of the disc portion 25a. As described above, the active vibration damping device 1 is supported by the vehicle body frame (not shown) via the support shaft 38 (FIG. 1A).

### <First Liquid Chamber Forming Portion and Second Liquid Chamber Forming Portion>

Next, the first liquid chamber forming portion 6 (see FIG. 2A) and the second liquid chamber forming portion 7 (see FIG. 2A) will be described. Here, the second liquid chamber forming portion 7 (see FIG. 2A) will be described, and then the first liquid chamber forming portion 6 (see FIG. 2A) will be described.

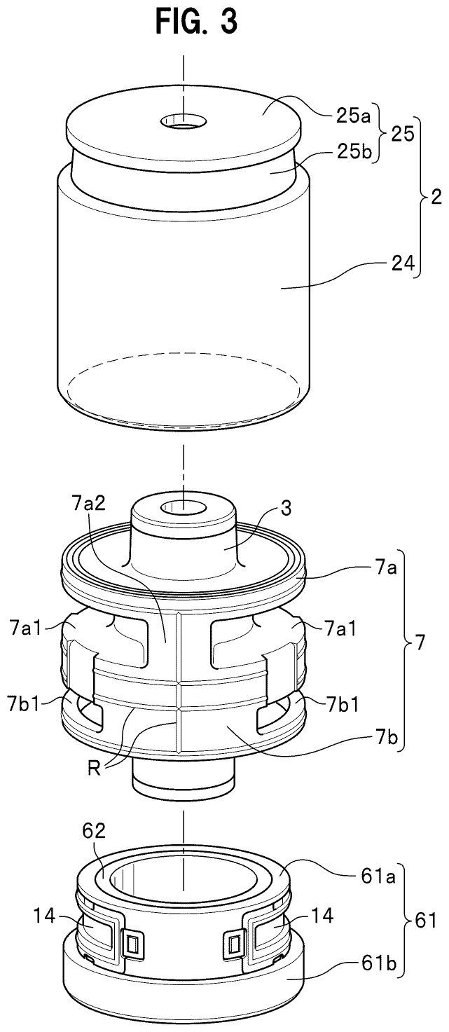

FIG. 3 is an exploded perspective view of the active vibration damping device 1 (see FIG. 2A). As shown in FIG. 3, the second liquid chamber forming portion 7 has a substantially top shape with the inner cylinder 3 as an axis. To be more specific, the second liquid chamber forming portion 7 has a substantially columnar portion 7a which is to be press-fitted into the outer cylinder body 24 and a cylindrical portion 7b into which a small-diameter cylindrical portion 61a of the first liquid chamber forming portion 6 described later is fitted. The substantially columnar portion 7a and the cylindrical portion 7b have the same outer diameter and are integrally formed so as to be coaxial with each other. The cylindrical portion 7b is press-fitted into the outer cylinder body 24 together with the substantially columnar portion 7a. In FIG. 3, the reference numeral R denotes a rib formed on the outer peripheral surface of the second liquid chamber forming portion 7. These ribs R function as a sealing member of a second liquid chamber 21 (see FIG. 5) filled with a liquid 20a (see FIG. 5) described later when the second liquid chamber forming portion 7 is press-fitted into the outer cylinder body 24.

As shown in FIG. 3, a pair of groove portions 7a1 are formed in the substantially columnar portion 7a. The pair of groove portions 7al extend along the circumferential direction of the substantially columnar portion 7a at positions sandwiching the inner cylinder 3 therebetween. The pair of groove portions 7a1 are formed to face each other at phases of 180° with the inner cylinder 3 interposed therebetween. That is, the pair of groove portions 7al are formed in the substantially columnar portion 7a so as to sandwich the partition wall 7a2 extending in the radial direction of the substantially columnar portion 7a.

A pair of slits 7b1 are formed in the cylindrical portion 7b. Each of the pair of slits 7b1 extends in the circumferential direction of the cylindrical portion 7b and are formed to be parallel to each of the pair of groove portions 7al in the axial direction. Note that the opening of the slit 7b1 that faces the inside of the cylindrical portion 7b is liquid-tightly closed by the flexible member 14 when the small-diameter cylindrical portion 61a of the first liquid chamber forming portion 6 is fitted into the cylindrical portion 7b.

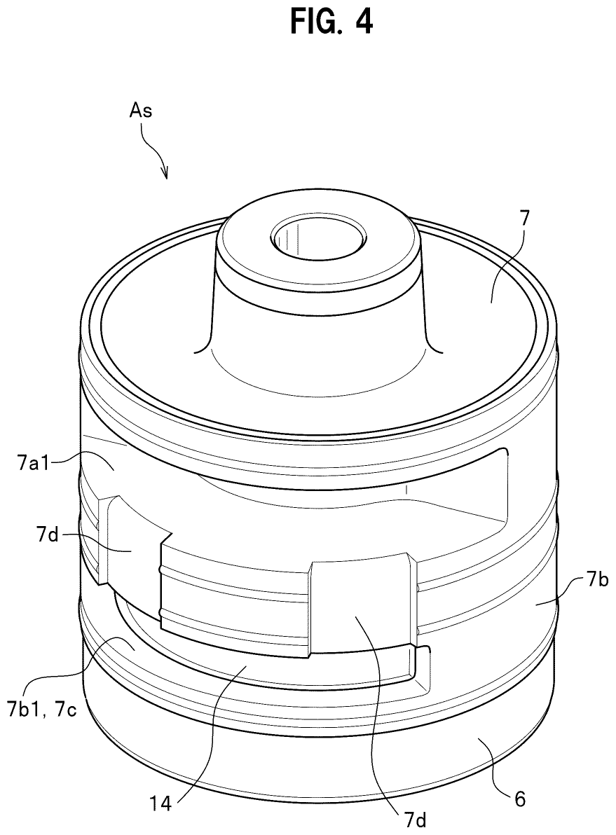

FIG. 4 is an overall perspective view of an assembled body As of the second liquid chamber forming portion 7 and the first liquid chamber forming portion 6. As shown in FIG. 4, the assembled body As is configured such that the small-diameter cylindrical portion 61a (see FIG. 3) of the first liquid chamber forming portion 6 is press-fitted into the cylindrical portion 7b of the second liquid chamber forming portion 7. Thus, the opening of the slit 7b1 facing the inside of the cylindrical portion 7b is liquid-tightly closed by the flexible member 14, which will be described in detail later. Thus, the slit 7b1 forms a groove 7c extending in the circumferential direction of the cylindrical portion 7b with the flexible member 14 as a bottom portion. That is, the groove portion 7c is formed so as to correspond to the groove portion 7al of the substantially columnar portion 7a.

The second liquid chamber forming portion 7 has a groove portion 7d that connects the groove portion 7a1 and the groove portion 7c. The groove portion 7d in the present embodiment is formed in a pair so as to extend from both end portions of the groove portion 7c in the circumferential direction toward the groove portion 7al side. That is, the groove portion 7d is formed from the substantially columnar portion 7a to the cylindrical portion 7b in the second liquid chamber forming portion 7. The groove portion 7d is formed as a recessed portion in which the outer peripheral surfaces of the substantially columnar portion 7a and the cylindrical portion 7b are partially recessed radially inward.

FIG. 5 is a sectional view taken along line V-V in FIG. 1B. FIG. 5 shows a state in which an assembled body As of the second liquid chamber forming portion 7 and the first liquid chamber forming portion 6 is disposed inside the outer cylinder 2. As shown in FIG. 5, the groove 7al of the second liquid chamber forming portion 7 is closed by the inner peripheral surface of the outer cylinder 2 to form a main liquid chamber 21a. The groove 7c of the second liquid chamber forming portion 7 is closed by the inner peripheral surface of the outer cylinder 2 to form an adjacent liquid chamber 21b adjacent to the main liquid chamber 21a. The groove 7d of the second liquid chamber forming portion 7 is closed by the inner peripheral surface of the outer cylinder 2 to form a connection passage 21c connecting the main liquid chamber 21a and the adjacent liquid chamber 21b.

The main liquid chamber 21a, the adjacent liquid chamber 21b, and the connection passage 21c are integrated to form the second liquid chamber 21. To be specific, the second liquid chamber 21 includes an adjacent liquid chamber 21b located on the radially outer side of the flexible member 14, and a main liquid chamber 21a located on the opposite side of the adjacent liquid chamber 21b with the elastic body 8 interposed therebetween in the axial direction. The active vibration damping device 1 includes a connection passage 21c between the cage 9 and the outer cylinder 2. The connection passage 21c connects the main liquid chamber 21a and the adjacent liquid chamber 21b. The second liquid chamber 21 is filled with the liquid 20a as a vibration transmitting material. As the liquid 20a, for example, a known hydraulic fluid such as silicone oil or ester oil can be suitably used.

As shown in FIG. 5, the second liquid chamber forming portion 7 includes an elastic body 8 which is disposed between the outer cylinder body 24 of the outer cylinder 2 and the inner cylinder 3 and forms a substantially columnar portion 7a and a cylindrical portion 7b, and a substantially cylindrical cage 9 which is embedded in the elastic body 8 along the inner peripheral surface of the outer cylinder 2.

The elastic body 8 in the present embodiment is a molded product of synthetic rubber, and is vulcanization-bonded to the outer peripheral surface of the inner cylinder 3. As shown in FIG. 5, the elastic body 8 has a tubular covering portion 8a for supporting the substantially columnar portion 7a and the cylindrical portion 7b on the inner cylinder 3. The tubular covering portion 8a covers substantially the entire outer peripheral surface of the inner cylinder 3. The elastic body 8 elastically supports the second liquid chamber forming portion 7 and the first liquid chamber forming portion 6, being integrated with the second liquid chamber forming portion 7 by the outer cylinder 2, on the outer peripheral surface of the inner cylinder 3. That is, the elastic body 8 allows the inner cylinder 3 to be displaced relatively to the outer cylinder body 24 in the axis-orthogonal direction in cooperation with the cylindrical elastic portion 25b constituting the outer cylinder 2.

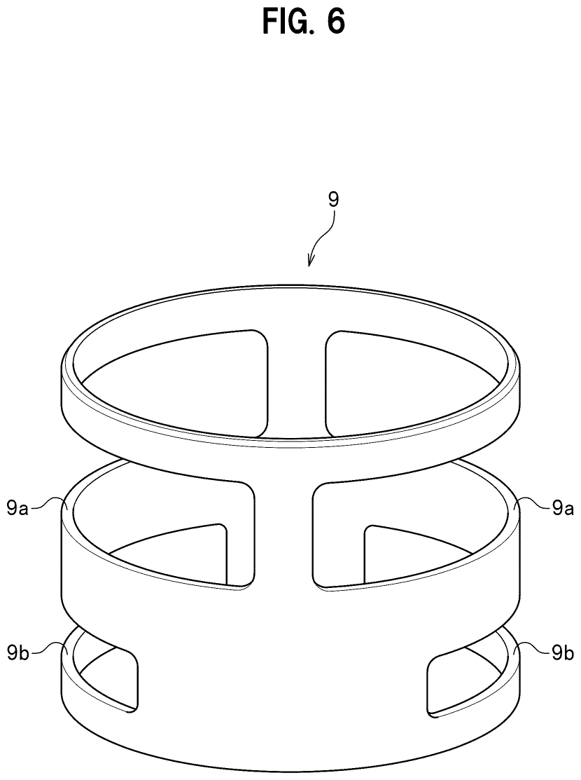

The cage 9 is embedded in the elastic body 8 by insert molding. FIG. 6 is an overall perspective view of the cage 9. As shown in FIG. 6, the cage 9 has two cutout portions 9a that correspond to the main liquid chamber 21a (see FIG. 5) and two cutout portions 9b that correspond to the adjacent liquid chamber 21b (see FIG. 5). The cage 9 is a substantially cylindrical body formed of a thin metal plate. As shown in FIG. 2B, the cage 9 contains the elastic body 8 on the radially inner side of the cage 9. As will be described in detail later, the cage 9 functions as a strain release member for releasing residual strain generated after vulcanizing the elastic body 8 (see 2B in FIG. 1) by drawing the cage 9. Examples of the material of the cage 9 include a steel plate, an aluminum plate, a copper plate, and a titanium plate, but the material is not limited thereto as long as drawing process can be performed on the material. Among other things a steel plate is preferable as the material of the cage 9.

Next, the first liquid chamber forming portion 6 (see FIG. 3) will be described. As shown in FIG. 3, the first liquid chamber forming portion 6 includes the flexible member 14, an outer member 61 to which the flexible member 14 is attached, and an inner member 62 which is fit into the outer member 61.

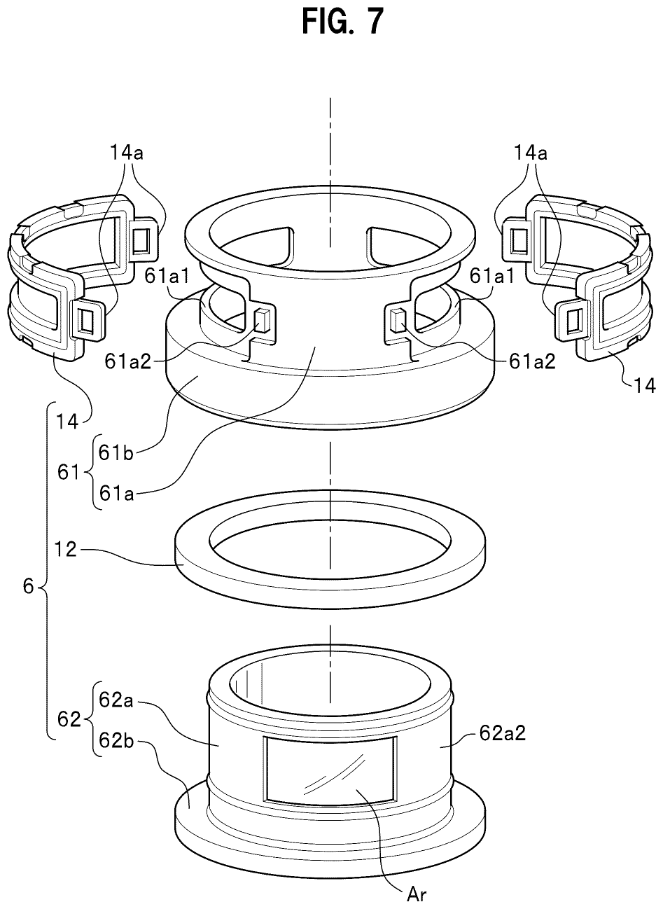

FIG. 7 is an exploded perspective view of the first liquid chamber forming portion 6. As shown in FIG. 7, the outer member 61 includes a small-diameter cylindrical portion 61a and a large-diameter cylindrical portion 61a having a larger radius than the small-diameter cylindrical portion 61b. A pair of slit-shaped cutout portions 61a1 extending in the circumferential direction are formed in the small-diameter cylindrical portion 61a. The circumferential dimension of the cutout portions 61al corresponds to the circumferential dimension of the groove 7c (see FIG. 4) in the second liquid chamber forming portion 7 (see FIG. 4). The cutout portion 61al communicates through the small-diameter cylindrical portion 61a. The outer member 61 is formed of a magnetic material such as iron, cobalt, nickel, or an alloy thereof.

As shown in FIG. 7, the flexible member 14 is attached to the small-diameter cylindrical portion 61a from the outside of the small-diameter cylindrical portion 61a so as to close the cutout portion 61al. The flexible member 14 is formed of a long and narrow plate body made of synthetic rubber which is curved along the outer peripheral surface of the small-diameter cylindrical portion 61a. A ring for lock 14a is formed at both ends of the flexible member 14 in its longitudinal direction. The flexible member 14 is attached to the outer peripheral surface of the small-diameter cylindrical portion 61a by fitting the ring for lock 14a into the locking projection 61a2 formed on the outer peripheral surface of the small-diameter cylindrical portion 61a. Incidentally, the flexible member 14 is disposed so that the plate-width direction of the flexible member 14 extends along the axial direction of the inner cylinder 3 as shown in FIG. 2A.

The flexible member 14 in the present embodiment is sandwiched between the inner peripheral surface of the cylindrical portion 7b of the second liquid chamber forming portion 7 and the outer peripheral surface of the small-diameter cylindrical portion 61a of the first liquid chamber forming portion 6. However, the support structure of the flexible member 14 is not limited thereto, and the flexible member 14 may be integrally connected to at least one of the cylindrical portion 7b and the small-diameter cylindrical portion 61a.

As shown in FIG. 7, the inner member 62 includes a fitting cylindrical portion 62a fitted into the small-diameter cylindrical portion 61a of the outer member 61, and a flange portion 62b formed at one end of the fitting cylindrical portion 62a in the axial direction. As shown in FIG. 2B, the outer diameter of the flange portion 62b is set so as to be accommodated in the inner peripheral side of the large-diameter cylindrical portion 61b of the outer member 61.

As shown in FIG. 2B, the fitting cylindrical portion 62a of the inner member 62 is formed by coating the cylindrical core member 62al made of a magnetic material with a coating 62a2 made of synthetic rubber. As shown in FIG. 2B, the coating 62a2 is provided on the entire surfaces of the fitting cylindrical portion 62a except for a portion where an orifice 15a is formed which is described later in detail. The flange portion 62b in the inner member 62 is formed of a magnetic material and is formed so as to continuously protrude outward from one end portion of the core material 62al in the axial direction. Examples of the magnetic material forming the core material 62al and the flange portion 62b include iron, cobalt, nickel, and alloys thereof.

As shown in FIG. 5, when the inner member 62 is press-fitted into the outer member 61, the coating 62a2 of the fitting cylindrical portion 62a of the inner member 62 is liquid-tightly contact with the inner peripheral surface of the small-diameter cylindrical portion 61a in the outer member 61. A slit-like cutout portion 61a1 formed in the small-diameter cylindrical portion 61a forms a first liquid chamber 15 between the flexible member 14 and the fitting cylindrical portion 62a. The first liquid chamber 15 is filled with the magnetic viscoelastic fluid 20b. As the magneto-viscoelastic fluid 20b, a known magneto-rheological fluid (MRF) or magneto-rheological compound (MRC) in which magnetic powder is dispersed in mineral oil or synthetic oil is preferably used.

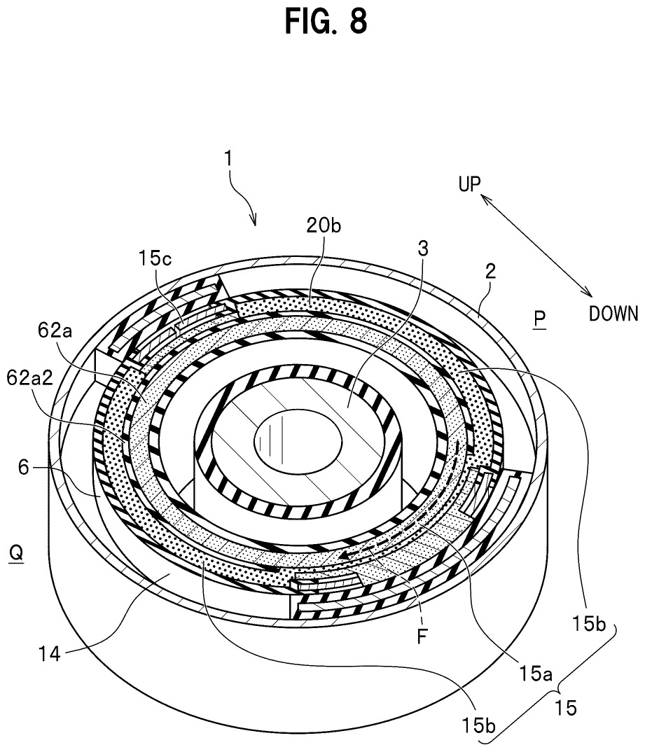

Next, the orifice 15a (see FIG. 5) constituting a part of the first liquid chamber 15 (see FIG. 5) will be described in more detail. FIG. 8 is a partially enlarged perspective view of the active vibration damping device 1 including a section taken along line VIII-VIII in FIG. 2B. As shown in FIG. 8, the first liquid chamber 15 extends annularly along the circumferential direction of the first liquid chamber forming portion 6 except for the separation portion 15c provided at a position opposed to the orifice 15a with the inner tube 3 interposed therebetween. The orifice 15a, which is a part of the first liquid chamber 15, is formed to have a smaller cross-sectional area than that of the general portion 15b of the first liquid chamber 15 in the radial direction. As described above, the general portion 15b of the first liquid chamber 15 is formed between the inner surface of the flexible member 14 and the outer peripheral surface of the fitting cylindrical portion 62a. In contrast, the orifice 15a is formed by a space between the rectangular region Ar having no coating 62a2 shown in FIG. 7 and the small-diameter cylindrical portion 61a of the outer member 61 facing the rectangular region Ar. That is, the orifice 15a is formed to have a width corresponding to the width of the coating 62a2 on the fitting cylindrical portion 62a as shown in FIG. 8. The active vibration damping device 1 of the present embodiment is configured such that the orifice 15a is positioned vertically lower side as shown in FIG. 8 when the active vibration damping device 1 is mounted on the rear suspension 30 as shown in FIG. 1B

The cross sectional area of the connection passage 21c in the second liquid chamber forming portion 7 shown in FIG. 5 is set in such a manner that the resistance generated when the liquid 20a flows through the connection passage 21c is smaller than the resistance generated when the magneto-rheological fluid 20b flows through the orifice 15a in a state where the magnetic field from the electromagnetic coil 12 (magnetic field generator) is not applied.

As shown in FIG. 7, the first liquid chamber forming portion 6 is configured such that the electromagnetic coil 12 (magnetic field generator) is accommodated in the large-diameter cylindrical portion 61b of the outer member 61. More specifically, the electromagnetic coil 12 is disposed in an annular space between the large-diameter cylindrical portion 61b of the outer member 61 and the flange portion 62b of the inner member 62 as shown in FIG. 2B.

As shown in FIG. 2B, when the inner member 62 is press-fitted into the outer member 61, the large-diameter cylindrical portion 61b of the outer member 61 and the inner member 62 are magnetically connected to each other. The coating 62a2 magnetically insulates the small-diameter cylindrical portion 61a of the outer member 61 from the core member 62a1 of the fitting cylindrical portion 62a except for the portion where the orifice 15a is formed. Thus, the outer member 61, the core 62al of the inner member 62, and the flange 62b of the inner member 62 form a magnetic path Mc passing through the magneto-viscoelastic fluid 20b in the orifice 15a by the magnetic field generated by the electromagnetic coil 12.

The outer member 61, the core 62a1 of the inner member 62, and the flange 62b of the inner member 62 constitute “a magnetic body”. The first liquid chamber forming portion 6 as described above is not directly connected to the elastic body 8 as shown in FIG. 5. Specifically, the first liquid chamber forming portion 6 is fitted into the second liquid chamber forming portion 7 and is internally fitted into the outer cylinder 2. That is the first liquid chamber forming portion 6 is arranged radially outward of the inner cylinder 3 in such a manner that they are arranged apart from each other.

### <<Operation of Active Vibration Damping Device>>

First, the operation of the active vibration damping device 1 in a state where the electromagnetic coil 12 is not energized will be described. As shown in FIG. 5, when an external force L such as a load or vibration amplitude is input to the inner cylinder 3 in the direction perpendicular to the axis in the active vibration damping device 1, the relative position between the inner cylinder 3 and the outer cylinder 2 is displaced. In the situation shown in FIG. 5, the inner cylinder 3 is displaced toward the outer cylinder 2, and thus, the liquid pressure of the liquid 20a in the second liquid chamber 21 on the P side in FIG. 5 is increased. On the other hand, the liquid pressure of the liquid 20a in the second liquid chamber 21 on the Q side which is the opposite side with respect to the inner cylinder 3 is decreased with the inner cylinder 3 being displaced to move away from the outer cylinder 2.

When the liquid pressure of the liquid 20a of the P-side second liquid chamber 21 increases, the flexible member 14 on the P side is pressed in a direction toward the first liquid chamber 15, that is, toward the inner cylinder 3. In the second liquid chamber 21 on the Q side, when the liquid pressure of the liquid 20a is reduced, the flexible member 14 is pulled in a direction away from the inner cylinder 3. That is, in the active vibration damping device 1, the magneto-rheological fluid 20b in the general portion 15b of the P-side first liquid chamber 15 moves to the general portion 15b of the Q-side first liquid chamber 15 as shown in FIG. 8. The magneto-viscoelastic fluid 20b produces a flow F through the orifice 15a.

As shown in FIG. 5, when the flexible member 14 on the P side is pressed toward the inner cylinder 3, the liquid 20a flows from the main liquid chamber 21a to the adjacent liquid chamber 21b via the connection passage 21c. The liquid 20a generates a resistance when flowing through the connecting passage 21c. The active vibration damping device 1 exhibits a damping characteristic of input vibration by the fluid resistance of the liquid 20a.

As shown in FIG. 8, the magneto-rheological fluid 20b generates a fluid resistance when flowing from the general portion 15b of the first liquid chamber 15 on the P side to the general portion 15b of the first liquid chamber 15 on the Q side via the orifice 15a. The active vibration damping device 1 exhibits a damping characteristic of input vibration by the fluid resistance of the magneto-viscoelastic fluid 20b.

Next, the operation of the active vibration damping device 1 in a state where the electromagnetic coil 12 is energized will be described. As shown in FIG. 2B, the magnetic field generated by the energized electromagnetic coil 12 forms a magnetic path Mc passing through the magneto-rheological fluid 20b in the orifice 15a.

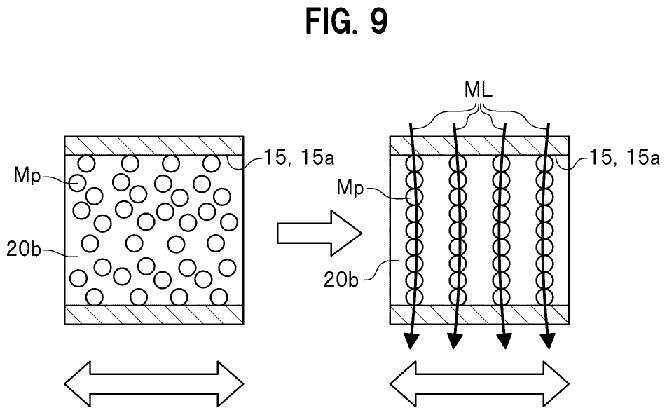

FIG. 9 is a diagram schematically illustrating the movement of the magnetic powder Mp when a magnetic field is applied to the orifice 15a of the first liquid chamber 15. As shown in the left drawing of FIG. 9, the magnetic viscoelastic fluid 20b in the orifice 15a of the first liquid chamber 15 keeps the predetermined fluidity in a state where no magnetic field is applied with the magnetic powder Mp being dispersed. In contrast, when the magnetic path Mc (see FIG. 6B) is formed by the generated magnetic field, the magnetic powder Mp is arranged along the magnetic fluxes ML as shown in the right drawing of FIG. 9. As a result, the apparent viscosity of the magneto-rheological fluid 20b increases, and the magnetic powders Mp arranged in the magneto-rheological fluid 20b act as valving elements to generate a fluid resistance in the orifice 15a. The active vibration damping device 1 exhibits a damping characteristic for input vibration by the fluid resistance of the magneto-rheological fluid 20b in the orifice 15a. The damping characteristic of the vibration is made variable by controlling the value of the current flowing through the electromagnetic coil 12 in accordance with the magnitude of the input vibration.

The active vibration damping device 1 of the present embodiment is configured to cause the magneto-viscoelastic fluid 20b in the first liquid chamber 15 to flow in accordance with a change in the liquid pressure of the liquid 20a in the second liquid chamber 21 when a load or a vibration magnitude is input to at least one of the inner cylinder 3 and the outer cylinder 2 from the outside. The active vibration damping device 1 controls the damping characteristics of vibration by the magnitude of the magnetic field (flux density) applied to the orifice 15a of the first liquid chamber 15.

According to the active vibration damping device 1, unlike a conventional active vibration damping device (see Japanese Patent Application Laid-Open No. 2021-71117) that directly converts an input such as vibration from the outside into a flow of the magnetic viscoelastic fluid, a flow of the magnetic viscoelastic fluid 20b in the first liquid chamber 15 is generated by a change in the liquid pressure of the liquid 20a in the second liquid chamber 21.

### <<Manufacturing Method>>

Next, a method of manufacturing the active vibration damping device 1 will be described with reference mainly to the components shown in FIG. 5. The manufacturing method includes: a process for manufacturing the second liquid chamber forming portion 7 having the second liquid chamber by attaching the elastic body 8 to the outer circumferential surface of the inner cylinder 3; a process of manufacturing the first liquid chamber forming portion 6 having the first liquid chamber 15 filled with the magneto-viscoelastic fluid 20a by assembling the electromagnetic coil 12 as the magnetic field generator, the magnetic outer member 61, the magnetic inner member 62, and the flexible member 14 in the liquid made of the magneto-viscoelastic fluid; and a process of manufacturing the assembled body As (see FIG. 4) by assembling the first liquid chamber forming portion 6 and the second liquid chamber forming portion 7 in such a manner that the first liquid chamber 15 and the second liquid chamber 21 are partitioned by the flexible member 14 extending in the axial direction of the inner cylinder 3, wherein the assembled body is supported by the magnetic body and the magnetic body and the inner cylinder 3 are connected by the elastic body 8; inserting the assembled body into the outer cylinder in the liquid to fix the assembled body into the outer cylinder with the second liquid chamber 21 being filled with the liquid.

The fixing step in this manufacturing method further includes a step of drawing the outer cylinder body 24 of the outer cylinder 2 radially inward. In this drawing process, the outer cylinder body 24 is plastically deformed so as to be slightly reduced in diameter. Further, since the diameter of the outer cylinder body 24 is reduced, the diameter of the cage 9 disposed inside the outer cylinder body 24 is also slightly reduced. The elastic body 8 disposed between the outer cylinder body 24 and the inner cylinder 3 is compressed. Thus, the residual strain generated in the elastic body 8 contracted after vulcanization is released by the drawing process.

### <<Effects>>

Next, the operation and effect of the active vibration damping device 1 according to the present embodiment will be described. The active vibration damping device 1 of the present embodiment generates the flow of the magneto-viscoelastic fluid 20b in the first liquid chamber 15 by the liquid pressure change of the liquid 20a in the second liquid chamber 21 as described above, unlike the conventional active vibration damping device (refer to Japanese Patent Application Laid-Open No. 2021-71117) which directly converts the input of the vibration from the outside into the flow of the magneto-viscoelastic fluid. According to the active vibration damping device 1 of the present embodiment, the response to input vibration can be improved by increasing the volume of the second liquid chamber 21 filled with the liquid 20a without increasing the volume of the first liquid chamber 15 filled with the magnetic viscoelastic fluid 20b.

Further, according to the active vibration damping device 1, unlike the conventional active vibration damping device (refer to Japanese Patent Application Laid-Open No. 2021-71117), the volume of the liquid chamber (the first liquid chamber 15) filled with the magnetic viscoelastic fluid 20b can be made relatively small, and therefore, the amount of the magnetic viscoelastic fluid 20b which is relatively heavy and expensive due to the magnetic powder Mp contained therein can be reduced.

Further, according to the active vibration damping device 1, unlike the conventional active vibration damping device (refer to Japanese Patent Application Laid-Open No. 2021-71117), the volume of the liquid chamber (the first liquid chamber 15) filled with the magnetic viscoelastic fluid 20b is adapted to be relatively small, which makes it possible to reduce the absolute amount of the magnetic powder Mp precipitated in the magnetic viscoelastic fluid 20b

Further, according to the active vibration damping device 1, since the volume of the liquid chamber (first liquid chamber 15) filled with the magnetic viscoelastic fluid 20b can be made relatively small, it is possible to redisperse the magnetic powder Mp by the flow F of the magnetic viscoelastic fluid 20b winding up the precipitated magnetic powder Mp. Further, according to the active vibration damping device 1, since the precipitation of the magnetic powder Mp due to aging can be suppressed, it is possible to keep favorable damping performance of vibration.

In the active vibration damping device 1, the first liquid chamber 15, the second liquid chamber 21, and the flexible member 14 extend along the circumferential direction of the active vibration damping device 1. According to the active vibration damping device 1, the device can be made compact while maintaining good response performance with respect to input vibration.

In the active vibration damping device 1, the electromagnetic coil 12 as the magnetic field generator, the outer member 61 as the magnetic body, the inner member 62 as the magnetic body, the first liquid chamber 15, and the second liquid chamber 21 are provided between the inner cylinder 3 and the outer cylinder 2 in the radial direction. The first liquid chamber 15 and the second liquid chamber 21 are partitioned by the flexible member 14. According to the active vibration damping device 1, the liquid 20a in the second liquid chamber 21 can efficiently generate the flow F of the magnetic viscoelastic fluid 20b in the first liquid chamber 15 regardless of whether vibration is input from the inner cylinder 3 or the outer cylinder 2.

In the active vibration damping device 1, the flexible member 14 extends in the axial direction of the inner cylinder 3. According to the active vibration damping device 1, for example, unlike a case where the flexible member 14 extends in the direction perpendicular to the axis of the inner cylinder 3 and the width of the flexible member 14 is limited to be less than the interval between the outer cylinder 2 and the inner cylinder 3, the width of the flexible member 14 can be secured to be large in the axial direction of the inner cylinder 3. That is, according to the active vibration damping device 1, the orifice 15a can be disposed so as to be widened in the axial direction without increasing the outer diameter of the active vibration damping device 1. Thus, the active vibration damping device 1 can increase the liquid column resonance frequency when the magnetic field is not generated by the electromagnetic coil 12. The frequency range of the lower spring in the active vibration damping device 1 can be increased. Further, according to the active vibration damping device 1, the orifice 15a can be disposed so as to be widened in the axial direction, and therefore, the membrane rigidity of the flexible member 14 can be reduced in the case where the magnetic field is not generated by the electromagnetic coil 12.

In the active vibration damping device 1, the flexible member 14 is held by the cage 9 positioned on the radially outer side of the flexible member 14 and the outer member 61 which is a magnetic body positioned on the radially inner side of the cage 9, and the elastic body 8 is connected to the cage 9 and is not connected to the outer member 61. According to the active vibration damping device 1, the elastic body 8 is not directly connected to the outer member 61 but is connected only to the cage 9, and thus the elastic body 8 (rubber leg) can be made longer. Thus, the active vibration damping device 1 can improve the durability of the elastic body 8 that expands and contracts due to vibration.

In the active vibration damping device 1, the outer cylinder 2 is drawn radially inward with the cage 9 disposed inside of the outer cylinder 2. According to the active vibration damping device 1, the outer cylinder 2 and the cage 9 can be more reliably integrated. Further, according to the active vibration damping device 1, the cage 9 is drawn radially inward together with the outer cylinder 2, which makes it possible to reduce the residual strain of the elastic body 8 generated at the time of vulcanization molding.

In the active vibration damping device 1, the cage 9 is formed only by a cylindrical portion extending along the outer cylinder 2. According to the active vibration damping device 1, the cage 9 is formed only by the cylindrical portion, which makes it easier to perform drawing on the cage 9.

In the active vibration damping device 1, the second liquid chamber 21 includes the adjacent liquid chamber 21b located on the radially outer side of the flexible member 14 and the main liquid chamber 21a located on the opposite side of the adjacent liquid chamber 21b with the elastic body 8 interposed therebetween in the axial direction. The active vibration damping device 1 includes a connection passage 21c between the cage 9 and the outer cylinder 2. The connection passage 21c connects the main liquid chamber 21a and the adjacent liquid chamber 21b. It is disadvantageously expected that the volume of the adjacent liquid chamber 21b is reduced if the flexible member 14 is disposed closer to the outer cylinder 2. However, according to the active vibration damping device 1, the main liquid chamber 21a and the adjacent liquid chamber 21b are connected to each other via the connection passage 21c, which makes it possible to secure a large volume of the entire second liquid chamber 21.

In the active vibration damping device 1, the cross-sectional area of the connection passage 21c is set in such a manner that the resistance generated when the liquid 20a flows through the connection passage 21c is smaller than the resistance generated when the magneto-viscoelastic fluid 20b flows through the orifice 15a in a state where the magnetic field from the electromagnetic coil 12 (magnetic field generator) is not acting. If the flow resistance of the liquid 20a in the connection passage 20c was set larger than the flow resistance of the magneto-viscoelastic fluid 20b in the orifice 15a, the range of change in rigidity when the magnetic field is changed by the electromagnetic coil 12 (magnetic field generator) would be reduced. That is, the controllable frequency band would be narrowed. In contrast, the active vibration damping device 1 makes it possible to prevent the controllable frequency band from being narrowed.

In the active vibration damping device 1, the first liquid chamber 15 is provided between the flexible member 14 and the outer member 61 made of a magnetic material, and the second liquid chamber 21 is provided between the flexible member 14 and the outer cylinder 2. According to the active vibration damping device 1, after the first liquid chamber 15 filled with the magnetic viscoelastic fluid 20b is formed, the second liquid chamber 21 filled with the liquid 20a is formed, which makes it easier to perform the filling process of the magnetic viscoelastic fluid 20b and the liquid 20a.

Further, a method of manufacturing the active vibration damping device 1 includes: manufacturing the second liquid chamber forming portion 7 which forms the second liquid chamber 21 by integrally molding the elastic body 8 on an outer surface of the inner cylinder 3; manufacturing a first liquid chamber forming portion 6 by combining the electromagnetic coil 12 which is the magnetic field generator, the outer member 61 which is the magnetic body, the inner member 62 which is the magnetic body, and the flexible member 14 in a liquid made of the magnetic viscoelastic fluid to make the first liquid chamber filled with the magnetic viscoelastic fluid; manufacturing an assembled body As by assembling the first liquid chamber forming portion 6 and the second liquid chamber forming portion 7 in such a manner that the first liquid chamber 15 and the second liquid chamber 16 are partitioned by the flexible member 14 extending in the axial direction of the inner cylinder 3 and are supported by outer member 61 which is the magnetic body and the outer member 61 and the inner cylinder 3 are connected by the elastic body 8; and fixing the assembled body As in the outer cylinder 2 by inserting the assembled body As into the outer cylinder 2 in the liquid 20a so that the second liquid chamber 21 is filled with the liquid 20a.

In a method of manufacturing a conventional active vibration isolator (for example, see Japanese Patent Application Laid-Open No. 2021-71117), a magneto-viscoelastic fluid is filled into a liquid chamber through a predetermined filling hole after the active vibration isolator is assembled as a whole. In such a conventional manufacturing method, there is a concern that the damping performance of vibration may be deteriorated due to the air bubbles remaining in the liquid chamber. In contrast, in the method of manufacturing the active vibration damping device 1 according to the present invention, the assembled body As is combined in the liquid made of the magneto-viscoelastic fluid 20b so as to fill the first liquid chamber 15 with the magneto-viscoelastic fluid 20b before the entire device is assembled. According to the manufacturing method of the present embodiment, it is possible to prevent the air bubbles from being left in the magnetic viscoelastic fluid 20b in the first liquid chamber 15.

In the method for manufacturing the active vibration damping device 1 according to the present invention, the fixing step further includes a step of drawing the outer cylinder 2 radially inward. According to the method of manufacturing the active vibration damping device 1, it is possible to reliably integrate the outer cylinder 2 and the cage 9. Further, according to the method of manufacturing the active vibration damping device 1, the residual strain at the time of vulcanization molding of the elastic body 8 can be reduced.

The active vibration damping device 1 of the present embodiment can be suitably used in place of various conventional mount bushes and suspension bushes which need to be carefully determined in consideration of safety performance, motion performance, comfort performance, riding comfort performance, and the like.

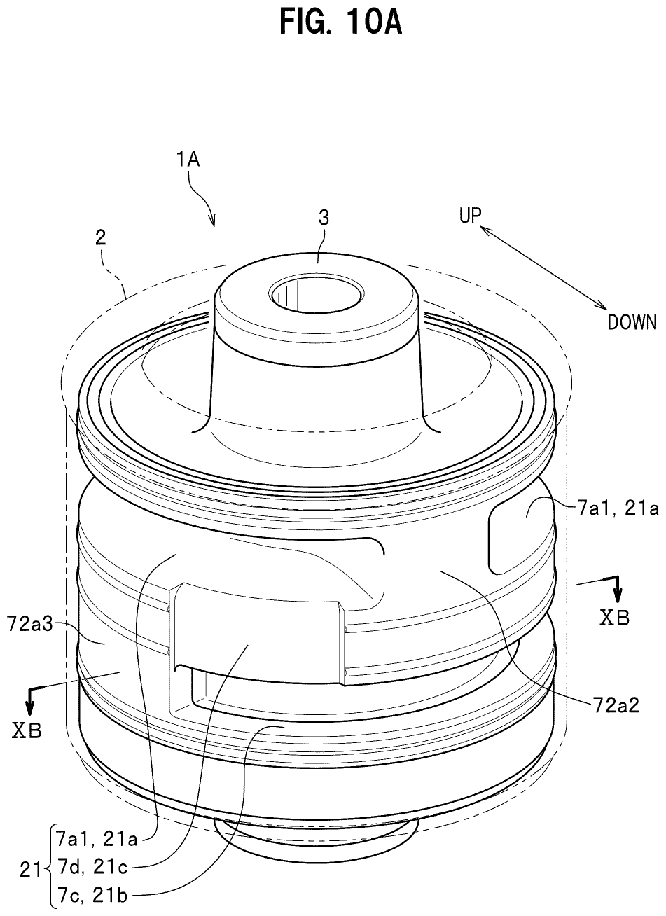

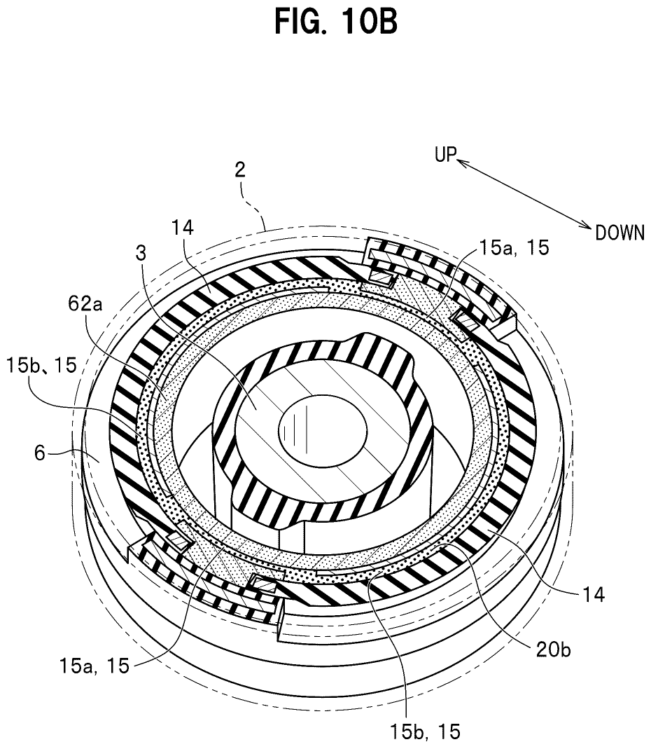

The present embodiment has been described above, but the present invention is not limited to the above embodiment and can be implemented in various forms. The active vibration damping device 1 of the embodiment has the orifice 15a only on the lower side in the vertical direction as shown in FIG. 8, but the present invention is not limited thereto. FIG. 10A is an overall perspective view of an active vibration damping device 1A according to another embodiment of the present invention. FIG. 10B is a cross-sectional view taken along XB-XB of FIG. 10A. In the active vibration damping device 1A according to the present invention, the same components as those of the active vibration damping device 1 of the embodiment are denoted with the same symbols, and detailed description thereof will be omitted. In FIG. 10A, the outer cylinder 2 is indicated by a virtual line (two dot chain line).

As shown in FIG. 10A, in the active vibration damping device 1A, a pair of main liquid chambers 21a are formed so as to sandwich a partition 72a2 (the first partition) extending in the vertical direction in a state where the active vibration damping device SL is attached to the trailing arm 34 (see FIG. 1A) of the rear suspension 30 (see FIG. 1A). Further, the adjacent liquid chambers 21b are formed in a pair so as to sandwich a partition 72a3 (the second partition) extending in a direction orthogonal to the extending direction of the partition 72a2 (the first partition) when viewed in the axial direction of the inner cylinder 3.

On the other hand, the general portion 15b of the first liquid chamber 15 is provided in the upper side and lower side of the active vibration damping device 1A (see FIG. 10A) corresponding to the adjacent liquid chamber 21b as shown in FIG. 10B. The orifice 15a of the first liquid chamber 15 is provided in the active vibration damping device 1A in correspondence with the partition 72a3 (see FIG. 10A) which is the second partition. The partition 72a2 (the first partition) and the partition 72a3 (the second partition) are connected to each other in the axial direction of the inner cylinder 3 as shown in FIG. 10A. That is, the orifice 15a of the active vibration damping device 1A attached to the rear suspension 30 (see FIG. 10A) is provided in a pair at positions displaced in phase by 90° as viewed in the axial direction with respect to the general portion 15b of the first liquid chamber 15 provided in a pair in the vertical direction. That is, the pair of orifices 15a are arranged to face each other on a horizontal plane.

According to such an active vibration damping device 1A, the main liquid chamber 21a and the adjacent liquid chamber 21b are offset in position, whereby the pair of orifices 15a are disposed so as to face each other on a horizontal plane. Therefore, even when the magnetic powder of the magneto-viscoelastic fluid 20b is precipitated downward in the vertical direction, the rigidity can be made variable.

### DESCRIPTION OF REFERENCE NUMERALS

1 Active vibration damping device
2 Outer cylinder
3 Inner cylinder
6: First liquid chamber forming portion
7: Second liquid chamber forming portion
9 Cage
12 Electromagnetic coil (magnetic field generator)
14 Flexible member
15 First liquid chamber
15a Orifice
20a Liquid
20b Magnetorheological fluid
21: Second liquid chamber
61 Outer member (magnetic body)
62al Core material (magnetic body)
62b Flange portion (magnetic body)
Mc Magnetic path

What is claimed is:

1. Active vibration damping device comprising:
an outer cylinder;
an inner cylinder disposed on an inner peripheral side of the outer cylinder;
a magnetic field generator that generates a magnetic field;
a magnetic body that forms a magnetic path by the magnetic field;
a first liquid chamber filled with a magneto-viscoelastic fluid;
a second liquid chamber adjacent to the first liquid chamber and filled with liquid, wherein
the magnetic field generator, the magnetic body, the first liquid chamber, and the second liquid chamber are provided between the inner cylinder and the outer cylinder in the radial direction,
the first liquid chamber and the second liquid chamber are partitioned by a flexible member,
the flexible member extends in an axial direction of the inner cylinder, and
a part of the first liquid chamber forms a flow path for the magnetic viscoelastic fluid positioned on the magnetic path.

2. The active vibration damping device according to claim 1, wherein the flexible member is held by a cage disposed on a radially outer side of the flexible member and the magnetic body disposed inner than the cage, and wherein the elastic body is connected to the cage and is not connected to the magnetic body.

3. The active vibration damping device according to claim 2, wherein the outer cylinder is drawn radially inward with the cage being located inside the outer cylinder.

4. The active vibration damping device according to claim 3, wherein the cage is formed only by a cylindrical portion extending along the outer cylinder.

5. The active vibration damping device according to claim 2, wherein the second liquid chamber includes an adjacent liquid chamber located radially outward of the flexible member and a main liquid chamber located opposite to the adjacent liquid chamber with the elastic body interposed therebetween in the axial direction, wherein
the second liquid chamber further include a connection passage between the cage and the outer cylinder, the connection passage connecting the main liquid chamber and the adjacent liquid chamber.

6. The active vibration damping device according to claim 5, wherein the active vibration damping device is a bush that connects a trailing arm to a vehicle body, wherein
the main liquid chamber is formed in a pair so as to sandwich a first partition wall extending in a vertical direction;
the adjacent liquid chamber is formed in a pair so as to sandwich a second partition wall extending in a direction intersecting an extending direction of the first partition wall when viewed in the axial direction;
the first liquid chamber is provided above and below the adjacent liquid chamber, and
the orifice of the first liquid chamber is provided at a position corresponding to the second partition wall.

7. The active vibration damping device according to claim 6, wherein a cross-sectional area of the connection passage is set in such a manner that a resistance generated when the liquid flows through the connection passage is smaller than a resistance generated when the magneto-rheological fluid flows through the orifice in a state where the magnetic field from the magnetic field generator is not applied.

8. The active vibration damping device according to claim 2, wherein the first liquid chamber is provided between the flexible member and the magnetic body, and wherein the second liquid chamber is provided between the flexible member and the outer cylinder.

9. A method of manufacturing the active vibration damping device according to claim 1, comprising:
manufacturing a second liquid chamber forming portion which forms the second liquid chamber by integrally molding the elastic body on an outer surface of the inner cylinder;
manufacturing a first liquid chamber forming portion by combining the magnetic field generator, the magnetic body, and the flexible member in a liquid made of the magnetic viscoelastic fluid to make the first liquid chamber filled with the magnetic viscoelastic fluid;
manufacturing an assembled body by assembling the first liquid chamber forming portion and the second liquid chamber forming portion in such a manner that the first liquid chamber and the second liquid chamber are partitioned by the flexible member extending in the axial direction of the inner cylinder and are supported by the magnetic body and the magnetic body and the inner cylinder are connected by the elastic body; and
fixing the assembled body in the outer cylinder by inserting the assembled body into the outer cylinder in the liquid so that the second liquid chamber is filled with the liquid.

10. The method of manufacturing the active vibration damping device according to claim 9, wherein the fixing the assembled body in the outer cylinder further includes a step of drawing the outer cylinder radially inward.
